(19) United States
(12) Patent Application Publication
(10) Pub. No.: US 2004/0223315 A1
(43) Pub. Date: Nov. 11, 2004

(54) Light emitting apparatus and method of making same

(75) Inventors: Yoshinobu Suehiro, Aichi-ken (JP); Mitsuhiro Inoue, Aichi-ken (JP); Hideaki Kato, Aichi-ken (JP)

Correspondence Address: MCGINN & GIBB, PLLC, 8321 OLD COURTHOUSE ROAD, SUITE 200, VIENNA, VA, 22182-3817, US

(73) Assignee: Toyoda Gosei Co., Ltd., Aichi-ken (JP)

(21) Appl. No.: 10/791,295

(22) Filed: Mar. 3, 2004

(30) Foreign Application Priority Data
Mar. 3, 2003 (JP) 2003-055851
Mar. 14, 2003 (JP) 2003-069290

(51) Int. Cl. F21V 21/00

(52) U.S. Cl. 362/84; 362/235; 362/249

(57) ABSTRACT

A light emitting apparatus has: a semiconductor light emitting element that emits light with a predetermined wavelength; a light-transmitting portion that has a recess to house the semiconductor light emitting element, the light-transmitting portion being of a light-transmitting material and the recess being formed by molding the light-transmitting material; and a phosphor layer portion that is thinly formed along the surface of the recess, the phosphor portion having a phosphor to be excited by irradiating light emitted from the semiconductor light emitting element.

The present application is based on Japanese patent application Nos.2003-055851 and 2003-069290. The entire contents of which are incorporated herein by reference.

### BACKGROUND OF THE INVENTION

1. Field of the Invention

This invention relates to a light emitting apparatus that light radiated from a light emitting diode (herein referred to as LED) is absorbed in phosphor and light with a different wavelength is then radiated being wavelength-converted thereby and relates to a method of making the light emitting apparatus.

Also, this invention relates to a light emitting apparatus that light radiated from LED is radiated through an optical system in a predetermined direction and a predetermined range.

2. Description of the Related Art

Japanese patent application laid-open No.2000-077123 (herein referred to as prior art 1) discloses a light emitting apparatus that light radiated from an LED chip is radiated being wavelength-converted by phosphor.

FIG. 1A is a cross sectional view showing the light emitting apparatus disclosed in prior art 1. The light emitting apparatus 30 is composed of: lead frames 31A, 31B; a cup 32 that is formed in the lead frame 31A; LED 33 that is disposed in the cup 32; bonding wires 34 that offer the electrical connection between electrodes of LED 33 and the lead frames 31A, 313; a sealing portion 35 that seals LED 33 in the cup 32; and epoxy resin 36 that seals the above elements and is shaped like a bullet lens

FIG. 1B is an enlarged cross sectional view showing the cup 32 and its vicinity. The sealing portion 3S is composed of a transparent spacer 35A that is of ultraviolet curing resin and seals LED 33, and a phosphor layer 35B that is formed on the transparent spacer 35A. In this composition, the phosphor layer 35B can be evenly irradiated and, thereby, uniform lighting of white light can be conducted.

However, in the above composition, since the luminescence area of phosphor layer 35B to radiate white light (wavelength-converted light) is nearly ten times that of LED 33, white light radiated from the phosphor layer 35B cannot be sufficiently converged by the converging optical system Namely. Since the phosphor layer 35B has a luminescence area not so small compared to the size of converging optical system, the phosphor layer 35B cannot be identified as a point light source thereto.

Namely, as shown in FIG. 3A, when the luminescence area of light source 39 is so small compared to the size of converging optical system 38 and therefore it can be identified as a point light source, light L radiated from the light source 39 can be sufficiently converged by the converging optical system 38. In contrast, as shown in FIG. 3B, when the luminescence area of light source 39 is not so small compared to the size of converging optical system 38 and therefore it cannot be identified as a point light source, light L radiated from the light source 39 cannot be sufficiently converged by the converging optical system 38. As a result, its convergence characteristic lowers. Due to the lowering of convergence characteristic, the light extraction efficiency of light emitting apparatus in a predetermined direction may lower.

FIG. 2 is a cross sectional view showing part of a light emitting apparatus in modification of prior art 1. In this modification, its light source is composed of LED 33 that is mounted on a substrate 37; a semisphere transparent spacer 35A that is of ultraviolet curing resin and seals LED 33; and a phosphor layer 35B that is formed on the transparent spacer 35A and is of phosphor material.

However, since the transparent spacer 35A and phosphor layer 35B are formed by dropping ultraviolet curing resin or phosphor material, it is difficult to control the shape and thickness with a high precision. If the phosphor layer 358 is formed thick locally, the light extraction efficiency may lower because light must be absorbed in such a local portion.

International publication No.99/09349 (herein referred to as prior art 2) discloses a light emitting apparatus that a LED chip is used as light source and an optical system is disposed close to the light source to reflect light radiated from the light source to a predetermined direction.

FIG. 4A is a cross sectional view showing the light emitting apparatus disclosed in prior art 2. FIG. 4B is a cross sectional view cut along the line C-C in FIG. 4A.

The light emitting apparatus is, as shown in FIG. 4A. Composed of: a light emitting element 60 to radiate light; a light source 62 that has a dome portion 61 and a base portion 61A formed integrated with the light emitting element 60; a lens element 72 that is composed of an incident surface 63, a first reflection region 64, a first reflection surface 64A, a direct light transmitting region 65, second reflection region 66, emission surface 67, edges 68, 69 and posts 70, 71; and an optical element 73 with pillow lens 73A arrayed. The second reflection region 66 of lens element 72 has a plurality of pairs of extraction surface 66A and step downs 66B formed around the first reflection region 64, The light source 62 is, as shown in FIG. 4B, fixed such that that the dome portion 61 is positioned at the center of first reflection region 64 by engaging recesses 62A, 62B of the base portion 61A to the posts 70, 71 of lens element 72.

In operation, light radiated from the light source 62 is entered through the incident surface 63 into the lens element 72. Part of this light is reflected by the first reflection surface 64A in the direction vertical to the center axis of light source 62, reflected by the extraction surface 66A in the direction of center axis, irradiated as light A through the emission surface 67 to the optical element 73. The other part of light is transmitted through the direct light transmitting region 65 in the direction of center axis, irradiated as light B to the optical element 73. Thus, the optical element 73 can radiate light with an enlarged lighting range.

However, the light emitting apparatus of prior art 2 has a problem that it must have an increased thickness since the dome portion 61 is provided as a separate body from the lens element 72.

Further, since the light source 62 and lens element 72 are individually manufactured and positioned by using the posts 70, 71 and recesses 62A, 62B (positioning means), the positioning precision depends on a precision in manufacturing the positioning means. In other words, if the manufacturing precision of positioning means is low, the positioning 9 precision cannot be adjusted in assembling them.

Further, since part of light laterally radiated cannot be converged in the direction of center axis, the light extraction efficiency may lower.

Also in the light emitting apparatus of prior art 2, the light emitting element 60 (light source) cannot be identified as a point light source since it is not so small compared to the size of dome 61 (converging optical system). As described earlier, light L cannot be sufficiently converged and, thereby, the convergence characteristic lowers. Due to the lowering of convergence characteristic, the light extraction efficiency of light emitting apparatus in the direction of center axis may lower.

### SUMMARY OF THE INVENTION

It is an object of the invention to provide a light emitting apparatus that has an enhanced extraction efficiency of white light to be radiated from phosphor layer.

It is another object of the invention to provide a light emitting apparatus that has an enhanced extraction efficiency of light while having a reduced thickness.

It is a further object of the invention to provide a method of making a light emitting apparatus that the shape and thickness of phosphor layer can be controlled with high precision.

It is a further object of the invention to provide a method of making a light emitting apparatus that the positioning precision in assembling can be easily adjusted

(1) According to first aspect of the invention, a light emitting apparatus comprises:

a semiconductor light emitting element that emits light with a predetermined wavelength;

a light-transmitting portion that includes a recess to house the semiconductor light emitting element, the light-transmitting portion being of a light-transmitting material and the recess being formed by molding the light-transmitting material; and

a phosphor layer portion that is thinly formed along the surface of the recess, the phosphor portion including a phosphor to be excited by irradiating light emitted from the semiconductor light emitting element.

(2) According to second aspect of the invention, a method of making a light emitting apparatus comprises the steps of:

preparing a light-transmitting portion that includes a at recess to house a semiconductor light emitting element, the light-transmitting portion being of a light-transmitting material and the recess being formed by molding the light-transmitting material, the recess being provided with a phosphor layer that is thinly formed along the surface of the recess;

forming an electrode of metal material;

mounting the semiconductor light emitting element on the electrode;

positioning the light-transmitting portion to the electrode; and

bonding the light-transmitting portion onto the electrode such that the phosphor layer of the recess surrounds the semiconductor light emitting element.

(3) According to third aspect of the invention, a light emitting apparatus comprises:

a light emitting element;

a power supply portion to supply electric power to the light emitting element;

a first optical system that is formed in a range of a predetermined angle to the center axis of the light emitting element when determining the center of emission surface of the light emitting element as origin point; and

a second optical system that includes a reflection plane disposed facing the emission surface of the light emitting element and a radiation face to externally radiate light being emitted from the light emitting element and then reflected on the reflection plane;

wherein the first optical system and the second optical system are disposed such that light being emitted from the light emitting element is externally radiated in the direction vertical to the center axis of the light emitting element.

(4) According to fourth aspect of the invention, a method of making a light emitting apparatus comprises the steps of:

forming a power supply portion;

mounting a light emitting element on the power supply portion;

positioning an optical system to the power supply portion, the optical system being composed of a first optical system that includes a recess to house the light emitting element and a convergence surface to converge light emitted from the light emitting element and then radiate it in the direction vertical to the center axis of the light emitting element, and a second optical system that includes a reflection plane to allow the total reflection of light emitted from the light emitting element and then radiate it in the direction vertical to the center axis of the light emitting element; and

bonding the optical system onto the power supply portion such that the light emitting element is surrounded by the recess.

(5) According to fifth aspect of the invention, a light emitting apparatus comprises:

a light emitting element;

a power supply portion to supply electric power to the light emitting element; and

an optical system that includes a recess to house the light emitting element, a light-guiding portion to guide light emitted from the light emitting element in the direction vertical to the center axis of the light emitting element, and a reflection portion to reflect light being guided through the light-guiding portion in the direction vertical to the center axis and then radiate it in the direction parallel to the center

### BRIEF DESCRIPTION OF THE DRAWINGS

The preferred embodiments according to the invention will be explained below referring to the drawings, wherein:

FIG. 1A is a cross sectional view showing the light emitting apparatus disclosed in prior art 1;

FIG. 1B is an enlarged cross sectional view showing the cup 32 and its vicinity in FIG. 1A;

FIG. 2 is a cross sectional view showing part of a light emitting apparatus in modification of prior art 1;

FIG. 3A is an illustration showing a convergence characteristic in case of a light source of relatively small size;

FIG. 3B is an illustration shoving a convergence characteristic in case of a light source of relatively large size;

FIG. 4A is a cross sectional view showing the light emitting apparatus disclosed in prior art 2;

FIG. 4B is a cross sectional view cut along the line C-C in FIG. 4A;

FIG. 5A is a cross sectional view showing a light emitting apparatus in a first preferred embodiment of the invention;

FIG. 5B is a partial enlarged cross sectional view showing LED 4 and its vicinity in FIG. 5A;

FIG. 5C is a cross sectional view cut along the line A-A in FIG. 5B;

FIG. 6 is a horizontal cross sectional view shoving part of a light emitting apparatus in a second preferred embodiment of the invention;

FIG. 7A is a cross sectional view showing a light emitting apparatus in a third preferred embodiment of the invention;

FIG. 7B is an enlarged cross sectional view showing an LED element 4 and its vicinity in FIG. 7A;

FIG. 7C is a horizontal cross sectional view cut along the line B-B in FIG. 71;

FIG. 8A is a cross sectional view showing a light emitting apparatus in a fourth preferred embodiment of the invention;

FIG. 8B is an enlarged cross sectional view showing an LED 4 and its vicinity in FIG. 8A;

FIG. 9 is a cross sectional view showing a light emitting apparatus in a fifth preferred embodiment of the invention;

FIG. 10 is a cross sectional view showing a light emitting apparatus in a sixth preferred embodiment of the invention;

FIG. 11 is a cross sectional view shoving a light emitting apparatus in a seventh preferred embodiment of the invention;

FIG. 12 is a cross sectional view showing a light emitting apparatus in an eighth preferred embodiment of the invention;

FIG. 13 is a cross sectional view showing a light emitting apparatus in a ninth preferred embodiment of the invention;

FIG. 14 is a cross sectional view showing a light emitting apparatus in a tenth preferred embodiment of the invention;

FIG. 15A is a cross sectional view showing part of a light emitting apparatus in an eleventh embodiment of the invention;

FIG. 15B is a cross sectional view cut along the line D-D in FIG. 15A;

FIG. 16 is a cross sectional view showing an LED housing recess 50 of a light emitting apparatus in a twelfth preferred embodiment of the invention;

FIG. 17A is a cross sectional view showing part of a light emitting apparatus in a thirteenth preferred embodiment of the invention;

FIG. 17B is a cross sectional view cut along the line E-E in FIG. 17A;

FIG. 18 is a cross sectional view showing a light emitting apparatus in a fourteenth preferred embodiment of the invention;

FIG. 19A is a top view showing a light emitting apparatus in a fifteenth preferred embodiment of the invention;

FIG. 19B is a cross sectional view cut along the line F-F in FIG. 19A;

FIG. 20A is a top view showing a light emitting apparatus in a sixteenth preferred embodiment of the invention; and

FIG. 20B is a cross sectional view cut along the line G-G in FIG. 20A.

### DETAILED DESCRIPTION OF THE PREFERRED EMBODIMENTS

[First Embodiment]

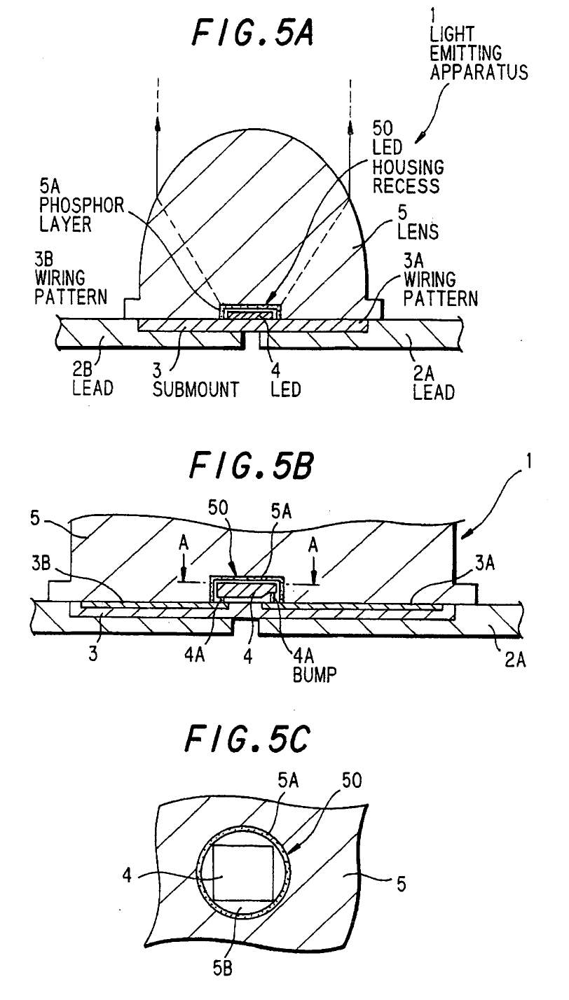

FIG. 5A is a cross sectional view showing a light emitting apparatus in the first preferred embodiment of the invention. FIG. 5B is a partial enlarged cross sectional view showing LED 4 in FIG. 5A and its vicinity. FIG. 5C is a cross sectional view cut along the line A-A in FIG. 5B.

In the below explanation, a term “convergence (or converging)” means, including to converge light like a spot in the direction of optical axis of LED, to converge light in the direction vertical to the optical axis of LED and to converge light in the direction of a predetermined angle to the optical axis of LED.

As shown in FIG. 5A, the light emitting apparatus 1 is composed of: leads 2A, 2B that are of metal material; a submount 3 that is provided on the LED-mounting side of leads 2A, 2B and has wiring patterns 3A, 3B provided on its surface; an LED element 4 that is mounted on the wiring patterns 3A, 3B; a lens 5 that is bonded to the leads 2A, 2B while surrounding the LED element A.

The submount 3 is of a material with high thermal conductivity, such as AlN. The LED element 4 is flip-chip bonded through bumps 4A onto the wiring patterns 3A and 3B formed on the submount 3. The wiring pattern 3A is electrically connected through a viahole (not shown) to the lead 2A, and the wiring pattern 3B is electrically connected through a viahole (not shown) to the lead 2B.

The LED element 4 is of a gallium nitride system compound semiconductor such as GaN, GaAlN, InGaN, InGaAlN etc- or ZnSe and emits blue series light with a wavelength of 450 to 480 nm. The LED element 4 mainly emits light from the side of sapphire substrate disposed on the back side of its electrode forming surface, and it has a chip size of 1000×1000 μm. The device structure of blue LED is well known and its explanation is omitted herein.

The lens 5 is shaped like a bullet by injection-molding transparent resin such as epoxy resin, and it is positioned at a predetermined position to the leads 2A, 2B on which the LED element 4 is mounted. Although not shown, the positioning is conducted such that concave portions on the leads 2A, 2B are engaged with convex portions on the lens 5. Alternatively, another positioning method may be used.

The lens 5 is, as shown in FIG. 5B, has a LED housing recess 50 that houses the LED element 4 when the lens 5 is positioned to the leads 2A, 2B. The LED housing recess 50 has a phosphor layer 5A formed on its surface. The LED housing recess 50, as shown in FIG. 5C, has such a size that a gap 5B between the LED housing recess SD and the LED element 4 can be minimized. The phosphor layer 5A is of Ce:YAG (yttrium aluminum garnet) to be excited by blue light above-mentioned and thereby to radiate yellow light.

In manufacturing the light emitting apparatus 1 thus composed, the leads 2A, 2B are formed by punching a metal member. In the process of forming the leads 2A, 2B by punching, the concave portions for positioning are simultaneously formed by 101 indentation method. Then, the submount 3 of a high thermal conductivity material is disposed on the device-mounting side of leads 2A, 2B. Then, the circuit patterns 3A, 3B of copper foil is formed on the surface of submount 3. Then, the LED element 4 is flip-chip bonded through the bumps 4A to the circuit patterns 3A, 3B while being positioned at a predetermined position thereof.

The lens 5 is made in separate process. First, by filling transparent resin in a mold with a shape of the lens 5, a bullet-shaped lens 5 with the LED housing recess 50 is made by injection-molding. In the process of injection molding, the concave portions for positioning are simultaneously molded. Then, the phosphor layer 5A is formed on the surface of LED housing recess 50 by coating thinly phosphor material.

Then, the lens 5 is positioned such that the convex portions are engaged with the concave portions on the leads 2A, 2B. At that time, the LED housing recess 50 of the lens 5 is filled with transparent silicon resin injected thereinto. Then, the lens 5 is fixed on the leads 2A, 2B while sealing the LED element 4 with silicon resin

The operation of the light emitting apparatus of the first embodiment will be described below.

A drive section (not shown) applies a drive voltage to the leads 2A, 2B. The LED element A emits blue light based on the drive voltage. Blue light emitted from the LED element 4 is irradiated to the phosphor layer 5A. The phosphor layer 5A is excited by blue light and radiates yellow light. Blue light is mixed with blue light in the phosphor layer 5A and, thereby, white light is generated. White light thus generated is entered into the lens 5, converged by the bullet-shaped lens 5, then radiated out of the lens 5. Thus, white light radiated is converged in a predetermined lighting range while having a homothetic ratio to be determined by the size of light source and the shape of optical system.

The effects obtained in the first embodiment are as follows.

(1) Since the external lens 5 is provided with the LED housing recess 50 and it is closely disposed surrounding the LED element 4 while providing the surface of LED housing recess 50 with the phosphor layer 5A, the phosphor layer 5A can be formed as a uniform and thin layer. With the uniform and thin phosphor layer 5A, the lowering of light intensity due to light absorption can be prevented. Also, since the size of light source can be minimized substantially without being influenced by the thickness of phosphor layer 5A, light radiated from the light source can be sufficiently converged like a spot by the converging optical system Thereby, the light intensity in a predetermined lighting range can be increased.

(2) Even when a large size LED element 4 (e.g., 1000 μm square) is used, a good convergence characteristic can be secured while suppressing the enlargement of light source size caused by covering the light source with phosphor layer 5A.

(3) Since the lens 5 is manufactured separately from the leads 2A, 2B with the LED element 4 mounted thereon, the LED element 4 on the leads 2A, 2B can be precisely positioned to the phosphor layer 5A of lens 5. Therefore, light radiated from the light source can be adjustably converged in a desired lighting direction and in a desired lighting range. Further, the shape of lens 5 can be optioned according to intended usage and convergence characteristic.

(4) In the method of forming the phosphor layer 5A on the surface of LED housing recess 50 of lens S, the way of forming a uniform and thin phosphor layer can be optioned. Therefore, the manufacturing cost can be reduced especially when an expensive phosphor material is needed to use since the amount used can be lowered.

(5) Since the LED element 4 is mounted on the leads 3A, 2B through the submount 3 with high thermal conductivity, the radiation property can be enhanced. Therefore, the light emitting apparatus thus composed can efficiently fulfill the requirement of large output for increased light intensity.

[Second Embodiment]

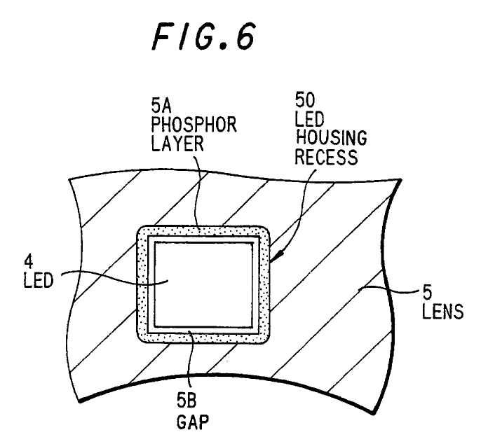

FIG. 6 is a horizontal cross sectional view showing part of a light emitting apparatus in the second preferred embodiment of the invention. Like components are indicated by the same numerals used in the first embodiment and the explanations are omitted below.

In the second embodiment, The LED housing recess 50 of lens 5 surrounding the LED element 4 is formed such that it has a rectangular shape similar to the shape of LED element 4. A gap between the LED element A and the phosphor layer 5A is further narrowed and, therefore the enlargement of light source size can be more effectively suppressed and the convergence characteristic of light radiated can be further enhanced.

[Third Embodiment]

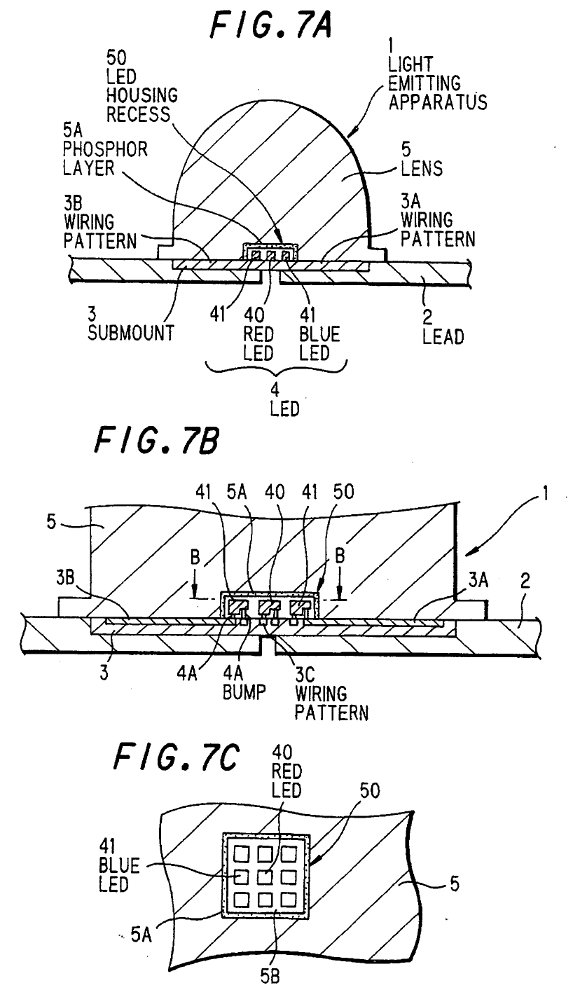

FIG. 7A is a cross sectional view showing a light emitting apparatus in the third preferred embodiment of the invention.

FIG. 7B is an enlarged cross sectional view showing an LED element 4 (red LED element 40 and blue LED element 41) and its vicinity. FIG. 7C is a horizontal cross-sectional view cut along the line B-B in FIG. 7B.

The light emitting apparatus 1 is composed of the LED element 4 that is mounted disposed at the wiring patterns 3A, 3B and 3C, respectively, formed on the submount 3 and a lens 5 that is bonded onto the leads 2A, 2B while surrounding the LED element 4.

The LED element E is, as shown in FIG. 7C, composed of a 2? red LED element 40 to emit red light and eight blue LED elements 41 disposed around the red LED element 40 that are flip-chip bonded to the wiring patterns 3A, 33 and 3C. The LED elements 40, 41 each have a chip size of 300×300 μm.

The phosphor layer 5A is of Ce:YAG to be excited by blue light radiated from the blue LED element 41 and thereby to radiate yellow light.

In the third embodiment, the color rendering property can be enhanced since red light radiated from the red LED element 40 is added to white light that is obtained by mixing blue light radiated from the blue LED element 41 with yellow light radiated from the phosphor layer 5A to be excited by that blue light.

Alternatively, ultraviolet LED elements may be disposed around the red LED element 40 instead of blue LED elements 41 while using a phosphor layer 5A including red, blue and green phosphors Thus, by entering ultraviolet light into such a phosphor layer 5A, white light can be obtained. Further, without using the red LED element 40, nine blue LED elements 41 may be disposed.

The LED housing recess 50 may be provided with a light diffusion layer on the surface as well as the phosphor layer 5A, so that light radiated from the LED element 4 can be diffused by the light diffusion layer. Thereby, a plurality of LED elements can approximate a continuous light source and the light source can be downsized.

[Fourth Embodiment]

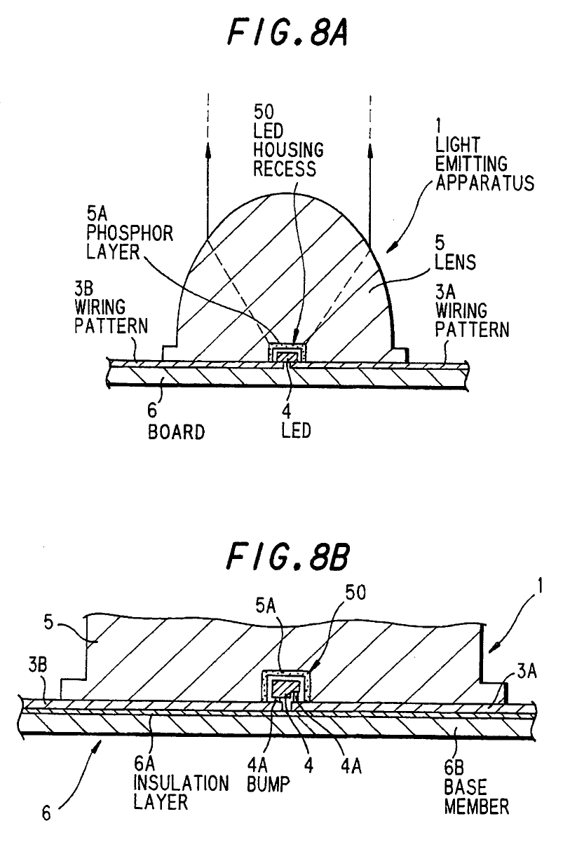

FIG. 8A is a cross sectional view showing a light emitting apparatus in the fourth preferred embodiment of the invention. FIG. 8B is an enlarged cross sectional view showing an LED 4 and its vicinity in FIG. 8A.

The light emitting apparatus 1, as shown in FIGS. 8A and 8B, employs a board 6 that is composed of: an insulation layer 6A; a base member 6 of excellent thermal conductivity material such as aluminum; and wiring patterns 3A, 3B of copper foil etc. provided on the surface of insulation layer 6A. The difference of the fourth embodiment from the first embodiment is that the LED element 4 of 300×300 μm, which is smaller than the LED element 6 in the first embodiment, is flip-chip bonded onto the wiring patterns 3A, 3B.

In the fourth embodiment, since the substrate 6 has an excellent heat radiation property, heat from the LED element 4 when turned on can be efficiently radiated through the board 6. Therefore, it can be applied to a high-output LED 4.

Further, since the thickness of phosphor layer 5 can be thinned even when the LED element d is downsized, the shielding of light due to the phosphor layer 5A can be avoided.

Still further, with such a small LED element 4, light generated can be converged into & smaller spot by the converging optical system. Thus, the light intensity in a predetermined lighting range can be enhanced.

[Fifth Embodiment]

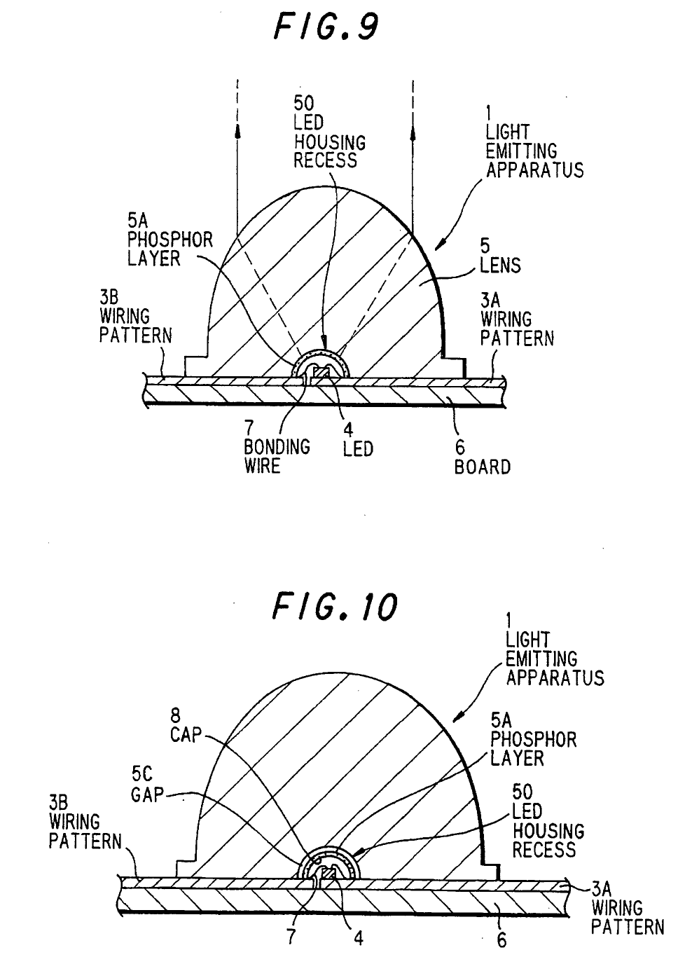

FIG. 9 is a cross sectional view showing a light emitting apparatus in the fifth preferred embodiment of the invention.

The light emitting apparatus 1 is structured such that an LED element 4 of 300×300 μm is face-up bonded onto the wiring pattern 3A provided on the board 6 explained in the fourth embodiment, and the electrodes of LED element 4 are electrically connected through bonding wires 7 to the wiring patterns 3A, 3B.

The lens 5 has a LED housing recess 50 that is shaped like a dome to surround the LED element 4 and bonding wires 7, and the LED housing recess 50 has a thin phosphor layer 5A on its surface. The inside of LED housing recess 50 is filled with transparent silicon resin (not shown) injected thereinto.

In the fifth embodiment, the enlargement of light source size can be suppressed even when the LED element d is face-up bonded. Therefore, the convergence characteristic as well as the light intensity can be enhanced. The dome shape of LED housing recess 50 is preferably formed to have a minimum radius while allowing the protection of the bonding wires 7 for example, it may be formed into a cone.

Although in the above embodiments the thin phosphor layer 5A is formed on the surface of LED housing recess 50 of the lens 5, the phosphor layer 5A may be formed independently of the lens 5 if it can be made sufficiently thin.

[Sixth Embodiment]

FIG. 10 is a cross sectional view showing a light emitting apparatus in the sixth preferred embodiment of the invention.

The light emitting apparatus 1 is composed of: an LED element e that is face-up bonded onto the wiring patterns 3A, 3B of board 6; a cap 8 that is of transparent resin and made independently of the lens 5 to surround the LED element 4 like a dome; and a phosphor layer 5A that is thinly formed on the outer surface of the cap B. The lens 5 is integrated with the board 6 while having a gap 5C lying between the LED housing recess 50 and the phosphor layer 5A. The inside of cap a is filled with transparent silicon resin injected thereinto.

In the sixth embodiment, the lens 5 is made independently of the phosphor layer 5A. Therefore, it is easy to control the thickness of phosphor layer 5A in forming the phosphor layer 5A on the outer surface of cap B. The shape of cap a is not limited to a dome as shown in FIG. 11 and may be, for example, a rectangle that can house an LED element A flip-chip bonded.

Although this embodiment is applied to the converging optical system that converges light in the optical axis direction of light source, it may be applied to a converging optical system that converges light in the direction vertical to the optical axis of light source.

[Seventh Embodiment]

FIG. 11 is a cross sectional view showing a light emitting apparatus in the seventh preferred embodiment of the invention.

The light emitting apparatus 1 is composed of a horizontal radiation type lens 5 that light emitted from the LED element 4 is radiated in the horizontal direction vertical to the optical axis, instead of the bullet-shaped lens 5 in the fourth embodiment. The horizontal radiation type lens 5 is integrally provided with a reflection plane SD that allows the total reflection of light emitted from the LED element A.

In the seventh embodiment, with the reflection plane SD to horizontally radiate light, the light extraction efficiency in the direction vertical to the optical axis can be enhanced and the convergence characteristic in the lateral direction of lens 5 can be enhanced. Thus, the light intensity in a predetermined horizontal lighting range can be increased.

This embodiment may be applied to a light emitting apparatus that radiates light through a converging optical system that is composed by combining a transmitting optical system and a reflecting optical system.

[Eighth Eodiment]

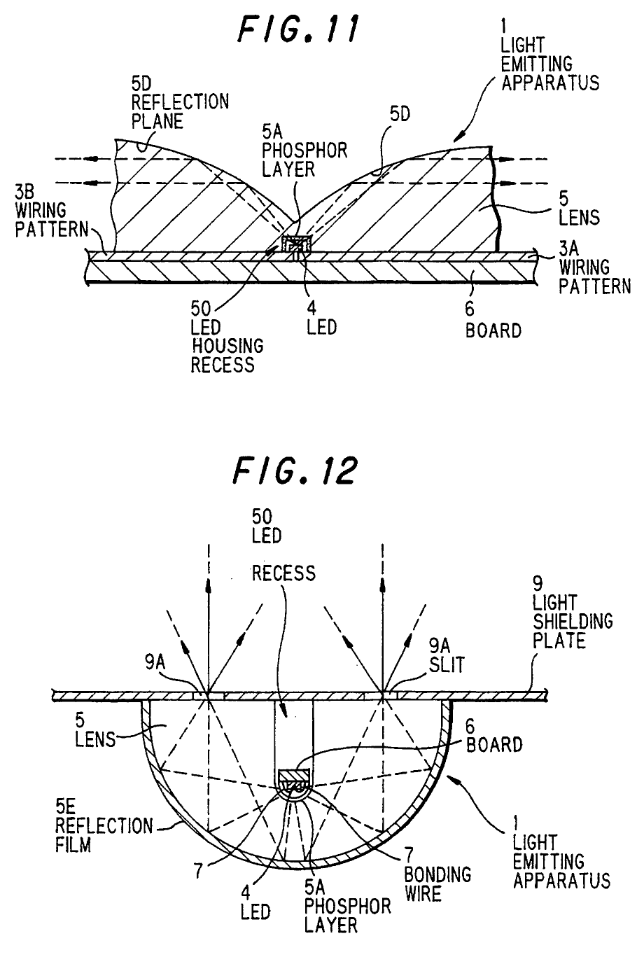

FIG. 12 is a cross sectional view showing a light emitting apparatus in the eighth preferred embodiment of the invention.

The light emitting apparatus 1 is composed of: an LED element 4 that is face-up bonded onto a board 6; a reflection-type lens 5 that is of transparent resin such as silicon resin etc. and disposed around the LED element A; and a light shielding plate 9 that has a slit 9A to allow the passing of light reflected by a reflection film 5E of the lens 5.

The lens 5 is formed having a semispherical inner shape, and an outer shape that is formed by rotating an ellipse which has the origin point of LED element A and the center point of slit 9A or 9B as its focal points and has the reflection film 5E of aluminum etc. to be formed on its outer surface by known film formation method such as sputtering.

Further, the lens 5 has a LED housing recess 50 to house the LED element 4 with the board 6, and the LED housing recess 50 has a tip portion shaped like a dome The tip portion has a thin phosphor layer 5A formed on its surface.

Light emitted from the LED element 4 is entered into the lens 5 through the phosphor layer 5A. Light transmitting through the lens 5 is then reflected on the reflection film 5E, radiated out of the lens 5 through the slits 9A.

In the eighth embodiment, even when light transmits through the lens 5 and is reflected on the reflection film 53 to be radiated through the slits 9A, an excellent convergence characteristic can be obtained because the light source is downsized.

Although in the above embodiments the LED housing recess 50 is formed in the lens 5, the LED housing recess 50 may be formed in a transparent member other than the lens 5. In this case, the converging optical system can be composed by integrating the transparent member with the lens 5.

[Ninth Embodiment]

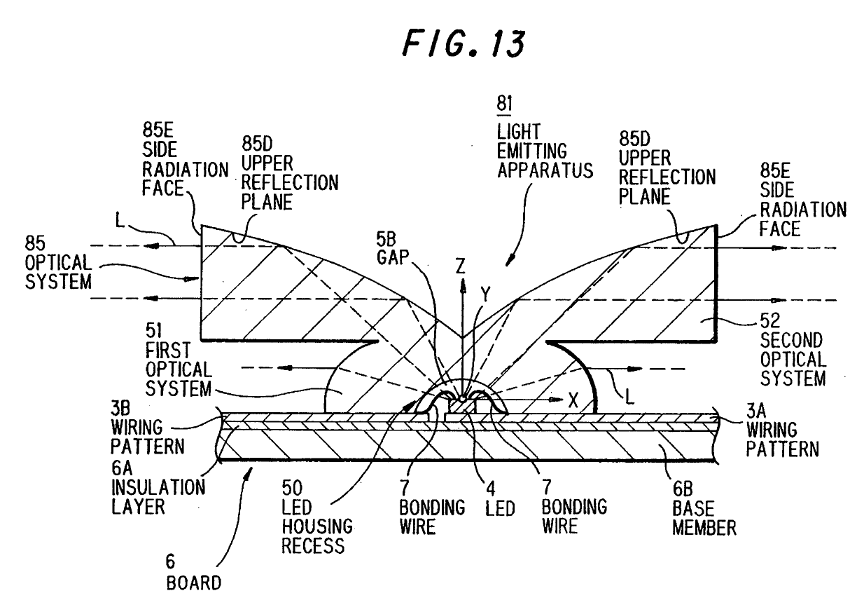

FIG. 13 is a cross sectional view showing a light emitting apparatus in the ninth preferred embodiment of the invention.

In the following explanations, it is defined that the center axis of light emitting element is a z-axis, a point on the upper surface crossed by the Z-axis is an origin point, and a coordinate system is provided with an X-axis and a Y-axis to intersect the Z-axis at the origin point. Like components are indicated by the same numerals used in the previous embodiments and its explanations are omitted below.

The light emitting element 81 is composed of: a board 6 that includes an insulation layer 6A, a base member 6B of an excellent thermal conductivity material such as aluminum etc., 1, and wiring patterns 3A, 3B formed on the insulation layer 6A; an LED element 4 that is face-up bonded onto the wiring pattern 3A; bonding wires 7 that offer the electrical connection between the electrodes (not shown) of LED element 4 and the lead frames 3A, 3B; and an optical system 85 that is bonded to the board 6 while surrounding the LED element 4 and bonding wires 7.

The wiring patterns 3A, 3B are formed by etching a copper foil layer bonded through the insulation layer 6A onto the base member GB to offer a predetermined circuit pattern, They are provided with a concave portion, which is formed by etching, to engage with a convex portion formed on the optical system 85.

The LED element 4 is of a gallium nitride system compound semiconductor such as GaN, GaAlN, InGaN, InGaAlN etc. or ZnSe and emits blue series light with a wavelength of 450 to 680 nm. The LED element 4 mainly emits light from its electrode forming surface and side face, and it has a chip size of 300×300 μm. The device structure of blue LED is well known and its explanation is omitted herein.

The optical system 85 is formed by injection-molding a transparent resin such as polycarbonate resin with a relatively high refractive index. It is composed of: a first optical system 51 that is disposed surrounding the LED element 4 to converge light in the nearly horizontal X-axis direction vertical to the Z-axis and; a second optical system 52 that is formed integrated with the first optical system 51 to radiate light in the nearly horizontal direction vertical to the Z-axis based on the total reflection; a LED housing recess 50 that is formed like a recess at the bottom of first optical system 51 to house the LED element 4 and bonding wires 7, The LED housing recess 50 has such a shape and size that a gap 5B between the LED housing recess 50 and the LED element 4 can be minimized.

The optical system 85 is bonded positioned at a predetermined position to the board 6 on which the LED element 4 is mounted. Although not shown, the positioning is conducted such that the concave portions on the board 6 are engaged with the convex portions on the optical system 85. Alternatively, another positioning method may be used.

The first optical system 51 is disposed surrounding the LED element 4 such that light is refracted in the direction vertical to the optical axis Z. It has a convex plane that allows radiation light of about 55 to 90 degrees to the Z-axis to be radiated refracted in the direction vertical to the Z-axis. Namely, the convex plane is shaped by rotating around the Z-axis an ellipse that has a symmetrical axis on the X-axis, a distance D₁ from its origin point to elliptic center, a diameter n*D₁ in the X-axis direction and a diameter \sqrt{n²−1}*D₁. n is a refractive index of lens material. In case of epoxy resin and polycarbonate resin, n=1.5. D₁ is an arbitrary value to determine a homothetic ratio.

The second optical system 52 has a circular reflection plane formed such that part of a parabola symmetrical to the X-axis and having the origin point of LED element 4 as its focal point is rotated 360 degrees around the Z-axis. It has an upper reflection plane 85D provided in an angle range of within 55 degrees to the Z-axis, and a side radiation face 85E that defines a column-like shape around the Z-axis and that light subjected to the total reflection by the upper reflection plane 85D is radiated in the side direction. According to use, the second optical system 52 may be provided with a flat plane at its center that allows the extraction of light in the direction of Z-axis.

The first optical system 51 and second optical system 52 are each other in position and dimension relationships such that, as shown in FIG. 13, all lights emitted from the LED element 4 and radiated in the direction of within 90 degrees to the Z-axis can reach the lens face of first optical system 51 or the upper reflection plane 85D of second optical system 52 and light reflected on the upper reflection plane 85D can reach the side radiation face 85S (in the Z-axis direction, the bottom of upper reflection plane 85D is located above the top end of lens face of first optical system 51). Therefore, the diameter of second optical system 52 should be greater than that of first optical system 51.

In manufacturing the light emitting apparatus 81, a board 6 with a copper foil layer formed on the surface is etched to form the wiring patterns 3A, 3B. Then, the LED element d is face-up bonded onto the surface of wiring pattern 3A. Then, the electrodes (not shown) of LED element 4 are electrically connected through the bonding wires 7 to the wiring patterns 3A, 3B.

The optical system 95 is made in separate process. First, by filling transparent resin in a split mold with the shape of optical system 85 (lens), the optical system 85 with the LED housing recess 50 is made by injection-molding. In process of injection molding, the concave portions for positioning are simultaneously molded.

Then, the optical system 85 is positioned such that the convex portions are engaged with the concave portions on the wiring patterns 3A, 3B. At that time, the LED housing recess 50 is filled with transparent silicon resin injected thereinto. Then, the optical system 95 is fixed on the wiring patterns 3A, 3B while sealing the LED element 4 with silicon resin.

The operation of the light emitting apparatus of the ninth embodiment will be described below.

A drive section (not shown) applies a drive voltage to the wiring patterns 3A, 3S. The LED element 4 emits blue light based on the drive voltage. Blue light emitted from the LED 26 element 4 is irradiated to the upper reflection plane 85D of second optical system 52 in a range of less than about 60 degrees from the Z-axis, subjected to the total reflection on the upper reflection plane 85D, entered vertically into the side radiation face 85E, radiated out of the optical system 85 in the direction vertical to the Z-axis. On the other hand, light in a range of about 60 to 90 degrees from the Z-axis is converged by the first optical system 51 and then radiated in the direction vertical to the Z-axis. Thus, nearly all blue lights emitted from the LED element 4 are externally radiated in the direction vertical to the Z-axis based on the total reflection and lens convergence.

The effects obtained in the ninth embodiment are as follows.

(1) The thickness of light source (composed of LED element 4 and optical system 85) to its diameter can be thinned.

(2) Although a deviation in light distribution characteristics of light source caused by an axis misalignment between light source and lens element (as in prior art 2) or a misalignment 10, between LED element 4 and optical system 85 becomes significant according as the degree of convergence increases, it can be prevented fundamentally Therefore, the distribution characteristics of light radiated in the lateral direction can be stabilized.

(3) The radiation efficiency in the lateral direction can be enhanced. Because, as described above, nearly all lights emitted from the LED element 4 are externally radiated in the direction vertical to the Z-axis based on the total reflection and lens convergence.

(4) An incident angle of light entering into the first optical system 51 from the LED element 4 and an incident angle of light entering into the side radiation face 85S can be controlled to be 35 degrees or less to reduce the interface reflection coefficient by using a material of n=1.5 for them (except for the upper reflection plane 85D to use the total reflection). Thereby, loss in interface reflection can be reduced. Further, since the basic optical system can optically control nearly all lights radiated from the LED element 4, the radiation efficiency does not lower or a reduction ratio of radiation efficiency can be lowered even when the diameter is reduced.

(5) Since the first optical system 51 and second optical system 52 to produce the lateral radiation are integrally structured, a misalignment of optical system to LED element 4 due to a physical shock is unlikely to occur Also, the number of parts or assembly steps does not increase. Further, a deviation in assembly precision does not increase.

The first optical system 51 can be formed being at an angle of up to θ=sin⁻¹(1/n) to the z-axis, though there is a slight influence on interface reflection. In case of n=1.5, it can be formed up to about 90 degrees to the Z-axis. In order to optically control nearly all light fluxes radiated from the LED element 4, it is necessary to form a reflection plane that covers about 40 degrees from the LED element 4 to the Z-axis. In general, the range of about 40 degrees to the Z-axis is a region that has a relatively large radiation intensity from the LED element 4. It is advantageous in external radiation efficiency to cover widely that region with the reflection plane. Namely, the first optical system 51 has a limited angle range where it can conduct the optical control, and according as the first optical system 51 is enlarged, loss in interface reflection is likely to occur at its end portion (high position in the Z-axis direction).

The first optical system 51 is not limited to a system to externally radiate parallel lights in the direction vertical to the Z-axis. For example, it may be a system to radiate lights converged in a range of about 30 degrees. In this case, the first optical system 51 may be formed up to about 35 degrees to the Z-axis, where the interface reflection is not so large.

When it is subjected to the interface reflection, it can be formed up to about 20 degrees to the Z-axis. In this case, a reflection plane to be formed is about 35 degrees and about 20 degrees to the Z-axis. However, since an edge is in molding difficult to form at discontinuous part of optical surface and a molding precision may lower due to occurrence of sink, it is desired that a range with a large radiation intensity from the LED element 4 is widely covered with a reflection plane, Therefore, the reflection mirror is preferably formed up to 40 degrees or more to the z-axis.

Similarly to the first optical system 51, the second optical system 52 may conduct the converged radiation in a certain width.

Although in the ninth embodiment the LED element 4 to radiate blue light is used, the LED element d to radiate red, green or ultraviolet light other than blue light may be used. The LED element 4 may be a large chip (e.g., 1000×1000 μm) of high-output type. The distance of LED element f and upper reflection plane 85D is relatively long and more than half of the radius of optical system 85. Therefore, even in case of a large LED element 4 or in case of a large light source that yellow phosphor to radiate yellow light when excited by blue light radiated from the LED element 4 is disposed around the LED element 4 to radiate white light by mixing blue light and yellow light, the total reflection of upper reflection plane 85D can be used.

The optical system 85 may be not transparent and colorless and may be colored Although the converged radiation of nearly parallel lights in the direction vertical to the Z-axis is explained above, light may be externally radiated in a predetermined circular range. Alternatively, light may be externally radiated in a certain width, not nearly parallel lights, in the direction nearly vertical, more than 45 degrees, to the Z-axis.

[Tenth Embodiment]

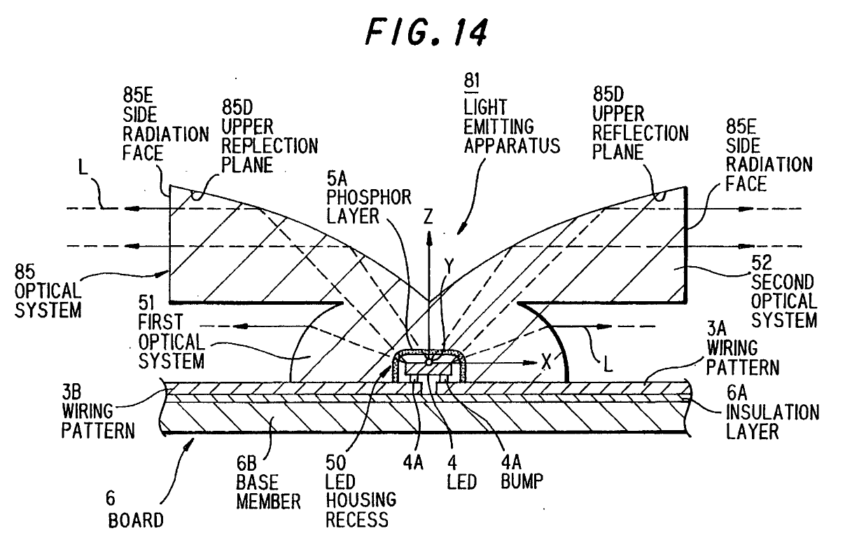

FIG. 14 is a cross sectional vies showing a light emitting apparatus in the tenth preferred embodiment of the invention.

The light emitting apparatus 81 is, different from that in the ninth embodiment, composed of: an LED element 4 that is a large chip of 100×1000 μm being flip-chip bonded through the bumps 4A; a LED housing recess 50 that houses the LED element 4; and a phosphor layer 5A that is of Ce:YAG (yttrium aluminum garnet) to radiate yellow light when excited by blue light radiated from the LED element 4 and is thinly formed on the surface of LED housing recess 50. The LED housing recess 50 has such a shape and size that a gap 5B between the LED housing recess 50 and the LED element 4 can be minimized.

In the tenth embodiment, since the LED housing recess 50 with phosphor layer 5A formed on the surface surrounds the LED element 4, white light can be radiated.

With the phosphor layer 5A formed uniformly and thinly, the lowering of light intensity due to light absorption can be prevented. Further, even when a large size LED element 4 is used, a high radiation efficiency and a good convergence characteristic can be secured while suppressing the enlargement of light source size caused by covering the light source with phosphor layer 5A.

[Eleventh Embodiment]

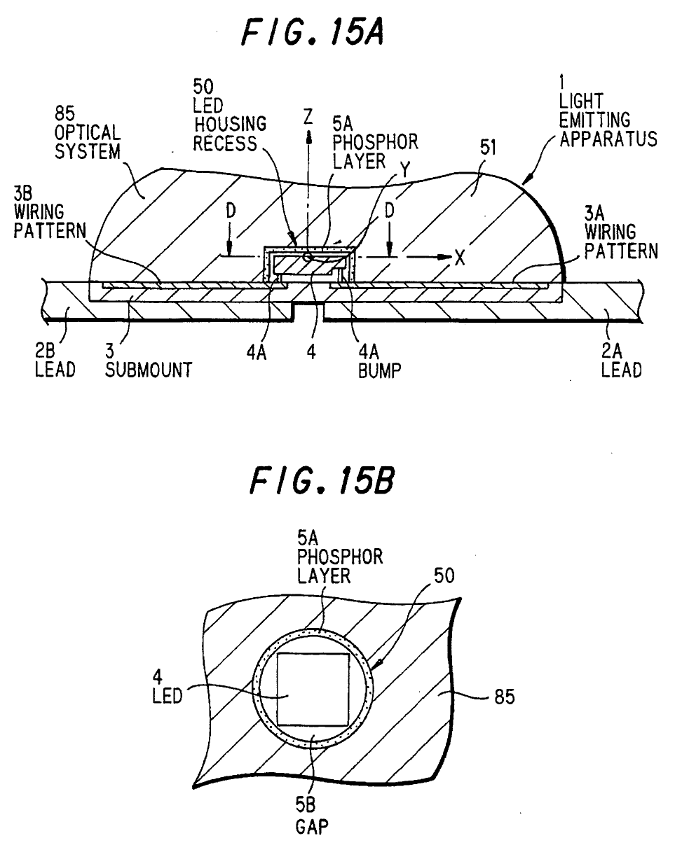

FIG. 15A is a cross sectional view showing part (the vicinity of first optical system 51) of a light emitting apparatus in the eleventh preferred embodiment of the invention. FIG. 15E is a cross sectional view cut along the line D-D in FIG. 15A.

The light emitting apparatus 01 is composed of: leads 2A, 2B that are of conductive material such as copper alloy and serve as a power supplying portion to mount a large size LED element 4; a submount 3 that is provided on the LED-mounting side of leads 2A, 2B and has wiring patterns 3A, 3B provided on its surface; and the LED element 4 that is flip-chip mounted through bumps 4A onto the wiring patterns 3A, 3B,

The submount 3 is of a material with high thermal conductivity, such as ANN. The LED element A is flip-chip bonded through the bumps 4A onto the wiring patterns 3A and 3B formed on the submount 3. The wiring pattern 3A is electrically connected through a viahole (not shown) to the lead 2A, and the wiring pattern 3B is electrically connected through a viahole (not shown) to the lead 2B.

The optical system 85 is positioned at a predetermined position by means of concavity-convexity engagement, with regard to the leads 2A, 2B with the LED element G mounted thereon. The LED housing recess 50 has a phosphor layer 5A thinly formed on its surface. The LED housing recess 50 is, as shown in FIG. 15B, structured such that a gap 53 between the LED housing recess 50 and LED element 4 can be minimized.

In manufacturing the light emitting apparatus 81 thus composed, the leads 2A 2B are formed by punching a metal member. In the process of forming the leads 2A, 2B by punching, the concave portions for positioning are simultaneously formed by indentation method. Then, the submount 3 of a high thermal conductivity material is disposed on the device-mounting side of leads 2A, 2B. Then, the circuit patterns 3A, 3B of copper foil is formed on the surface of submount 3. Then, the LED element 4 is flip-chip bonded through the bumps 6A to the circuit patterns 3A, 3B while being positioned at a predetermined position thereof.

The optical system 85 is made in separate process. First, by filling transparent resin in a mold with a shape of the optical system 85, the optical system 85 with the first optical system 51, second optical system 52 (not shown) and LED housing recess 50 is made by injection-molding. In the process of injection molding, the concave portions for positioning are simultaneously molded. Then, the phosphor layer 5A is formed on the surface of LED housing recess 50 by coating thinly phosphor material.

Then, the optical system 85 is positioned such that the convex portions are engaged with the concave portions on the leads 2A, 2B. At that time, the LED housing recess 50 is filled with transparent silicon resin injected thereinto. Then, the optical system 85 is fixed on the leads 2A, 2B while sealing the LED element 4 with silicon resin.

In the eleventh embodiment, since the large-sized LED element 4 is mounted on the wiring patterns 3A, 3B formed on the submount 3, heat from the LED element 4 when turned on can be rapidly and efficiently radiated through the leads 2A, 2B. Therefore, the light emitting apparatus can be sufficiently applied to a high-output type LED 4 and can be stably operated while suppressing a thermal shrinkage in the LED housing recess 50. Thus, the reliability thereof can be enhanced.

Meanwhile, the LED element 4 may have a chip size of 300×300 μm. In this case, by the downsizing of light source, the convergence characteristic can be enhanced to increase the light intensity in a desired lighting range.

[Twelfth Embodiment]

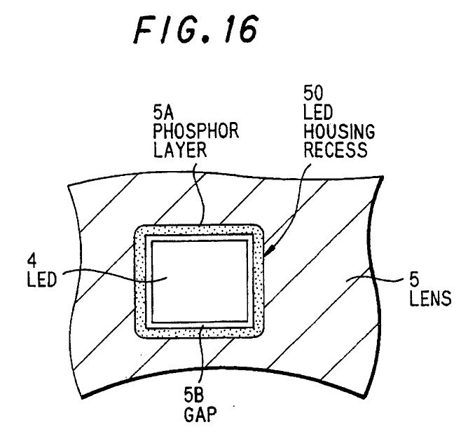

FIG. 16 is a cross sectional view showing the LED housing recess 50 of a light emitting apparatus in the twelfth preferred embodiment of the invention.

The optical system 85 has the LED housing recess 50 that is shaped rectangular like the LED element 4.

In the twelfth embodiment, since the gap 5 between the LED element 4 and phosphor layer 5A is further narrowed, the enlargement of light source size can be prevented further effectively and, thereby, the convergence characteristic of light radiated can be further enhanced.

[Thirteenth Emodient]

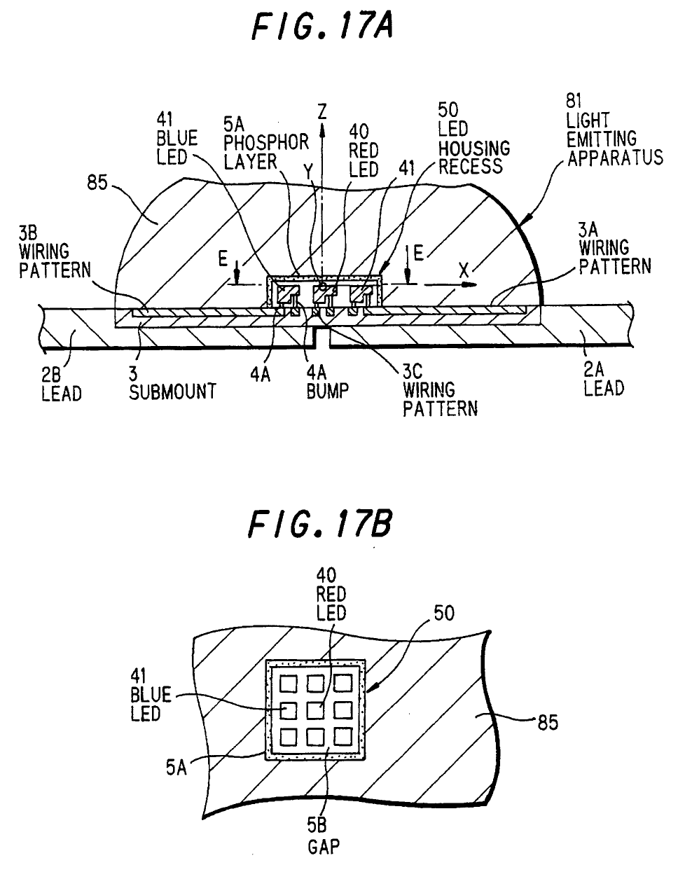

FIG. 17A is a cross sectional view showing part (the vicinity of first optical system 51) of a light emitting apparatus in the thirteenth preferred embodiment of the invention. FIG. 17B is a cross-sectional view cut along the line E-E in FIG. 17A.

The light emitting apparatus 81 is composed of a red LED element 90 and blue LED elements 41 that are flip-chip bonded onto wiring patterns 3A, 3B and 3C.

As shown in FIG. 17B, the eight blue LED elements 41 are disposed around the red LED element 40. The red LED element 40 and blue LED elements 41 have a chip size of 300×300 μm.

The phosphor layer 5A is of Ce:YAG that radiates yellow light when excited by blue light emitted from the blue LED element 41.

In the thirteenth embodiment, like the ninth embodiment, white light can be obtained by that blue light emitted from the blue LED element 41 is mixed with yellow light radiated from the phosphor layer 5A being excited by the blue light. In addition, in this embodiment, white light with a high color rendering property can be obtained by adding red light emitted from the red LED element 40 thereto.

Alternatively, ultraviolet LED elements 41 may be disposed around the red LED element 40 instead of blue LED element 41. Ultraviolet light emitted from the ultraviolet LED elements 41 is entered into the phosphor layer 5A with red, blue and green phosphors mixed therein and, thereby, white light can be radiated therefrom. Furthermore, nine ultraviolet LED elements 41 may be disposed without using the red LED element 60.

[Fourteenth Embodiment]

FIG. 10 is a cross sectional view showing a light emitting apparatus in the fourteenth preferred embodiment of the invention.

The light emitting apparatus 81 is composed of the second optical system 52 provided with a stepwise portion 85F.

In the fourteenth embodiment, the resin layer of optical system 85 can be formed in nearly equal thickness. Thereby, the molding property can be enhanced and a profile distortion in optical surface that may occur by sink etc can be reduced. Further, the producibility can be enhanced since the cooling time of thick resin portion can be eliminated. The amount of resin required can be reduced and the manufacturing cost can be reduced.

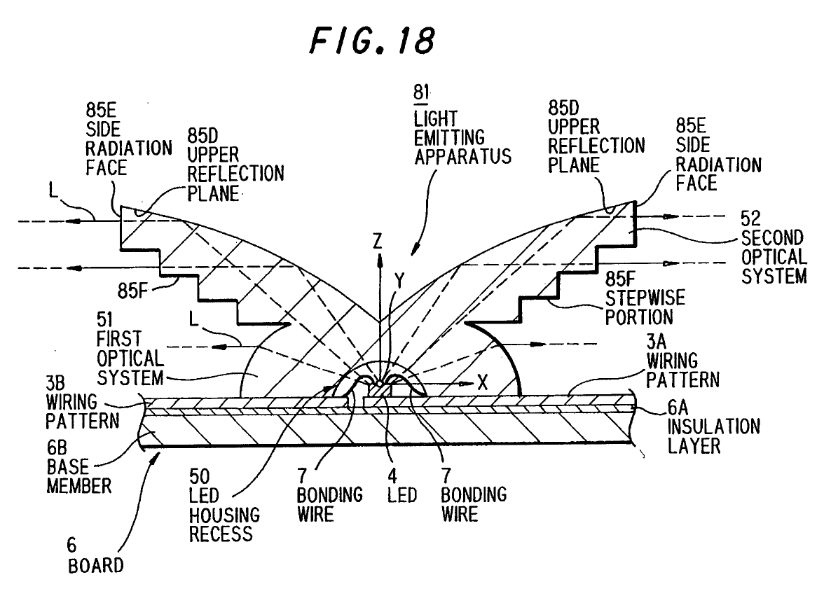

The stepwise portion 85F is not limited to the shape and number of steps as shown in FIG. 18.

The light emitting apparatus 81 may use a LED element 4 to be flip-chip bonded onto the wiring patterns 3A, 3S. Further, it may use a large-size LED element A to increase the light intensity.

[Fifteenth Embodiment]

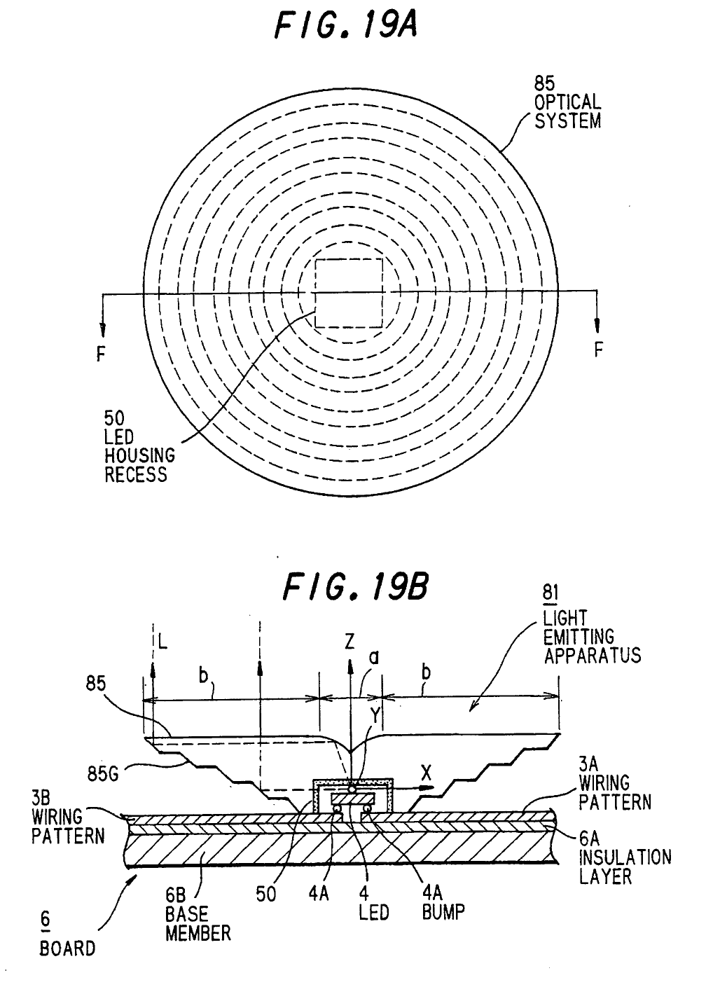

FIG. 19A is a top view showing a light emitting apparatus in the fifteenth preferred embodiment of the invention. FIG. 19B is a cross sectional view cut along the line F-F in FIG. 19A.

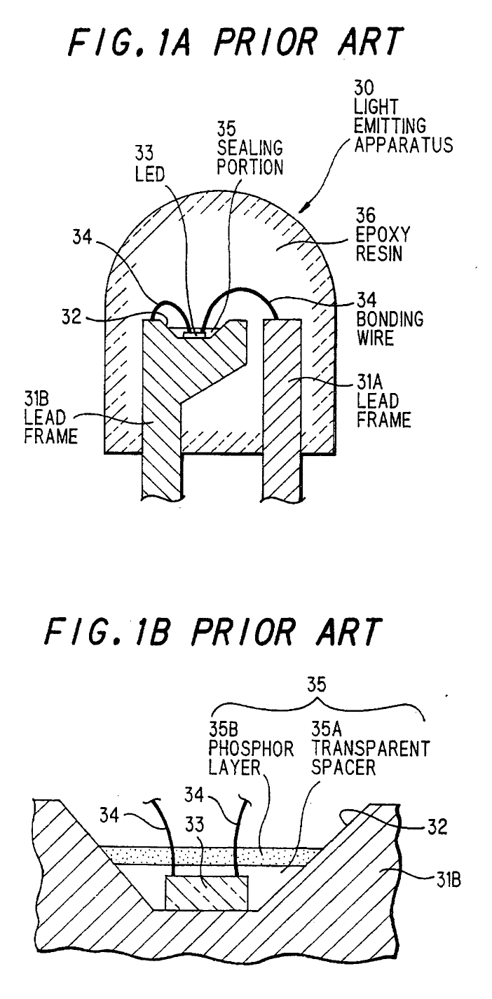

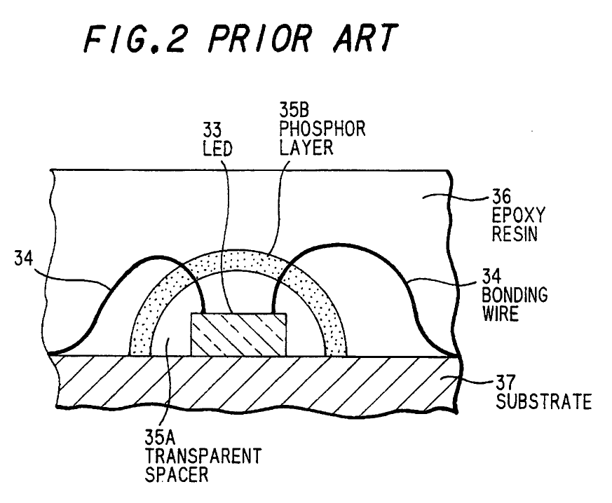

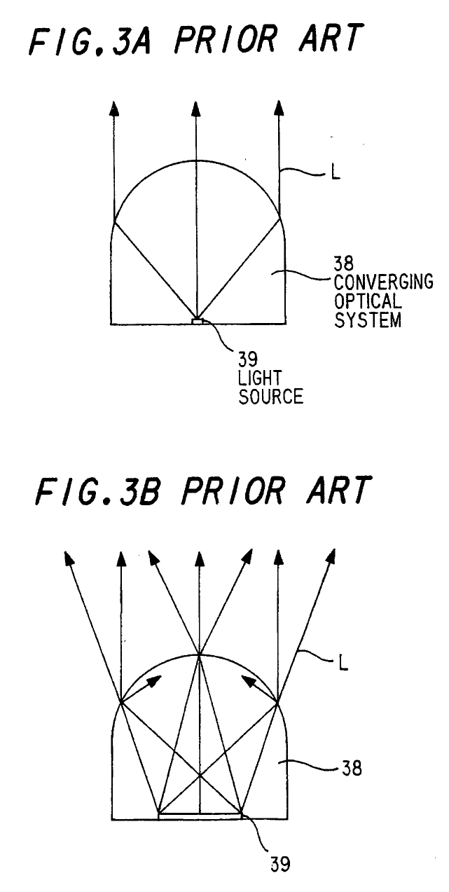

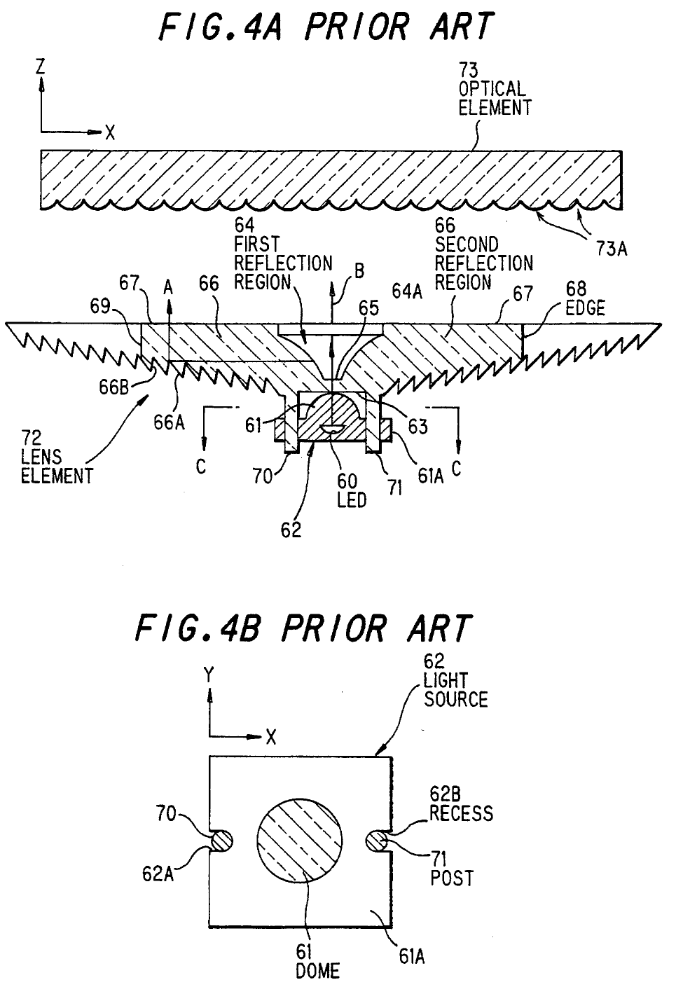

In this embodiment, the light emitting apparatus 81 is composed such that the optical system 95 in the tenth embodiment (FIG. 1) is composed of only the second optical system 52 while omitting the first optical system 51, and the optical system 85 is, as shown by cross section in FIG. 19B, provided with a plurality of stepwise circular reflection portions 85G on the bottom side (on the side of board 6). The reflection portions 85G have an inclined angle of 45 degrees. The optical system 85, as shown in FIG. 19B, has a surface that defines a parabolic cross section in region a close to LED 4 and defines a flat plane in region b outer than region a.

In operation, light emitted from LED 4 is mainly reflected in the direction parallel to the center axis of LED 6 by the reflection portions 85G. Since the optical system 85 has the parabolic plane in cross section in region a, light component emitted in the Z-axis direction is reflected horizontally on the parabolic plane in region a and is then reflected vertically on the reflection portions 85G, as shown in FIG. 19B.

In the fifteenth embodiment, since the optical system 85 has the parabolic plane in region a close to LED 4 and the circular reflection portions 85G, light component emitted near the center axis of LED 4 can be diffused in the radial direction of optical system 85. Therefore, the light intensity can be equalized.

[Sixteenth Embodiment]

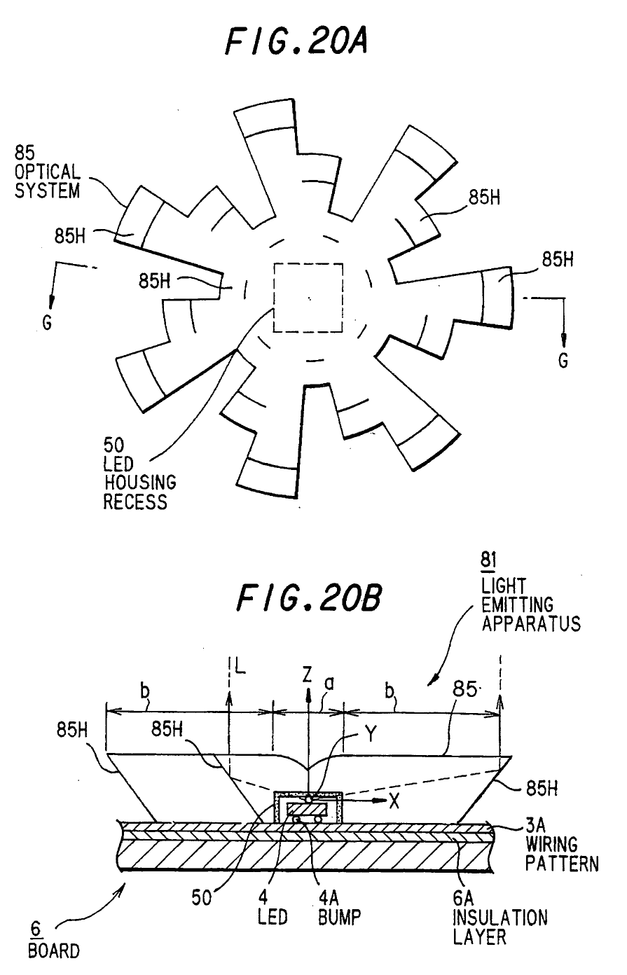

FIG. 20A is a top view showing a light emitting apparatus in the sixteenth preferred embodiment of the invention. FIG. 20B is a cross sectional view cut along the line G-G in FIG. 20A.

In this embodiment, the light emitting apparatus 91 is, different from the optical system Os in the fifteenth embodiment, composed of an optical system 85 that is provided with three reflection portions 85H, on the bottom side, which are disposed at intervals of predetermined angle (in this embodiment, 360/7 degrees) in the circumference direction and which are disposed at different positions each other in the radial direction. The reflection portions 85H have an inclined angle of 45 degrees The optical system 85, as shown in FIG. 20B, has a surface that defines a parabolic cross section in region a close to LED 6 and defines a flat plane in region b outer than region a.

In the sixteenth embodiment, since the three reflection portions 85H disposed at different positions in the radial direction are continuously disposed in the circumference direction of optical system 85, the brightness varies at different positions and thereby it looks glittering. Further, since the optical system 85 has the parabolic plane in region a close to LED 4 and the reflection portions 85H, light component emitted near the center axis of LED 4 can be diffused in the radial direction of optical system 85. Therefore, the light intensity can be equalized.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. A light emitting apparatus, comprising:
a semiconductor light emitting element that emits light with a predetermined wavelength;
a light-transmitting portion that includes a recess to house the semiconductor light emitting element, the light-transmitting portion being of a light-transmitting material and the recess being formed by molding the light-transmitting material; and
a phosphor layer portion that is thinly formed along the surface of the recess, the phosphor portion including a phosphor to be excited by irradiating light emitted from the semiconductor light emitting element.

2. The light emitting apparatus according to claim 1, wherein:
the light-transmitting portion has a light convergence shape to converge light emitted from the light emitting element.

3. The light emitting apparatus according to claim 1, wherein:
the semiconductor light emitting element is a flip-chip type LED element that emits light from its light emission surface located on the opposite side of its mounting surface.

4. The light emitting apparatus according to claim 1, wherein:
the recess is located close to the semiconductor light emitting element along the profile of the semiconductor light emitting element.

5. The light emitting apparatus according to claim 1, wherein:
the semiconductor light emitting element is composed of a plurality of LED elements disposed in a predetermined arrangement.

6. The light emitting apparatus according to claim 1, wherein:
the semiconductor light emitting element is composed of a plurality of LED elements with different emission wavelengths disposed in a predetermined arrangement.

7. A method of making a light emitting apparatus, comprising the steps of:
preparing a light-transmitting portion that includes a recess to house a semiconductor light emitting element, the light-transmitting portion being of a light-transmitting material and the recess being formed by molding the light-transmitting material, the recess being provided with a phosphor layer that is thinly formed along the surface of the recess;
forming an electrode of metal material;
mounting the semiconductor light emitting element on the electrode;
positioning the light-transmitting portion to the electrode; and
bonding the light-transmitting portion onto the electrode such that the phosphor layer of the recess surrounds the semiconductor light emitting element.

8. The method according to claim 7, wherein:
the phosphor layer is formed by spraying a phosphor material on the surface of the recess after forming the recess by molding.

9. The method according to claim 7, therein:
the electrode is a lead electrode provided on the surface of a submount member of high thermal conductivity.

10. The method according to claim 7, wherein:
the electrode is a copper-foil electrode provided through an insulation layer on the surface of a base member of high thermal conductivity.

11. The method according to claim 7, wherein:
the semiconductor light emitting element is flip-chip bonded onto the electrode.

12. A light emitting apparatus, comprising:
a light emitting element;
a power supply portion to supply electric power to the light emitting element;
a first optical system that is formed in a range of a predetermined angle to the center axis of the light emitting element when determining the center of emission surface of the light emitting element as origin point; and
a second optical system that includes a reflection plane disposed facing the emission surface of the light emitting element and a radiation face to externally radiate light being emitted from the light emitting element and then reflected on the reflection plane;
wherein the first optical system and the second optical system are disposed such that light being emitted from the light emitting element is externally radiated in the direction vertical to the center axis of the light emitting element.

13. The light emitting apparatus according to claim 12, wherein:
the predetermined angle is greater than 40 degrees.

14. The light emitting apparatus according to claim 12, wherein:
the first optical system and the second optical system optically control nearly all amount of light being emitted from the light emitting element to be externally radiated.

15. The light emitting apparatus according to claim 12, wherein:
the first optical system and the second optical system are of a material with a refractive index of about 1.5, and an incident angle of light to enter to the first optical system from the light emitting element and an incident angle of light reflected on the reflection plane to enter the radiation face from the light emitting element are 35 degrees or less.

16. The light emitting apparatus according to claim 12, wherein:
the second optical system includes: an upper circular reflection plane that is formed such chat part of a parabola symmetrical to an axis vertical to the center axis and having the center of emission surface of the light emitting element as its focal point is rotated 360 degrees around the center axis; and a side radiation face that radiates light subjected to total reflection by the upper reflection plane in the lateral direction.

17. The light emitting apparatus according to claim 12, wherein:
the second optical system allows part of light emitted from the light emitting element to be externally radiated as nearly parallel light in the direction vertical to the center axis of the light emitting element.

18. The light emitting apparatus according to claim 12, wherein:
the first optical system includes a recess to house the light emitting element, the recess being located close to the semiconductor light emitting element along the profile of the semiconductor light emitting element.

19. The light emitting apparatus according to claim 12, wherein:
the light emitting element is composed of a plurality of light emitting elements disposed in a predetermined arrangement.

20. The light emitting apparatus according to claim 12, wherein:
the light emitting element is composed of a plurality of light emitting elements with different emission wavelengths disposed in a predetermined arrangement.

21. A method of making a light emitting apparatus, comprising the steps of:
forming a power supply portion;
mounting a light emitting element on the power supply portion;
positioning an optical system to the power supply portion, the optical system being composed of a first optical system that includes a recess to house the light emitting element and a convergence surface to converge light emitted from the light emitting element and then radiate it in the direction vertical to the center axis of the light emitting element, and a second optical system that includes a reflection plane to allow the total reflection of light emitted from the light emitting element and then radiate it in the direction vertical to the center axis of the light emitting element; and
bonding the optical system onto the power supply portion such that the light emitting element is surrounded by the recess.

22. The method according to claim 21, wherein:
the first optical system includes a phosphor layer that is thinly formed by spraying a phosphor material on the surface of the recess after forming the recess by molding.

23. The method according to claim 21, wherein:
the bonding step is conducted after injecting transparent sealing resin into the recess.

24. A light emitting apparatus, comprising:
a light emitting element;
a power supply portion to supply electric power to the light emitting element; and
an optical system that includes a recess to house the light emitting element, a light-guiding portion to guide light emitted from the light emitting element in the direction vertical to the center axis of the light emitting element, and a reflection portion to reflect light being guided through the light-guiding portion in the direction vertical to the center axis and then radiate it in the direction parallel to the center axis.

25. The light emitting apparatus according to claim 24, wherein:
the optical system includes an overlying reflection portion by which light emitted from the light emitting element in the direction nearly over the light emitting element is reflected in the direction vertical to the center axis.
